(19) United States
(12) Patent Application Publication
(10) Pub. No.: US 2022/0270124 A1
(43) Pub. Date: Aug. 25, 2022

(54) METHOD AND APPARATUS FOR PROVIDING INFORMATION BASED ON LIST OF SEARCH RESULT OF ITEM

(71) Applicant: Coupang Corp., Seoul (KR)

(72) Inventors: Seung Hwan Lee, Seoul (KR); Moon Hee Kim, Seoul (KR); Catherine Chang, Seoul (KR); Ji Hye Ha, Seoul (KR)

(21) Appl. No.: 17/194,987

(22) Filed: Mar. 8, 2021

(30) Foreign Application Priority Data
Feb. 22, 2021 (KR) 10-2021-0023502

(51) Int. Cl. G06Q 30/02; G06F 16/9538; G06Q 30/06

(52) U.S. Cl. CPC G06Q 30/0213; G06F 16/9538; G06Q 30/0633

(57) ABSTRACT

Disclosed is a method of providing information on a server comprising obtaining a keyword from a user, identifying an item list corresponding to the keyword, identifying a ratio of items corresponding to a specific type among a plurality of items included in the item list, and, when the item corresponding to the specific type is an item that provides benefits related to membership subscription, and the ratio of the items satisfies a specific condition, providing a first page including first information related to the item list and second information on or regarding the benefits related to the membership subscription for the item corresponding to the specific type in the item list. Also disclosed is a method of providing information on a user terminal.

### BACKGROUND

### Technical Field

Example embodiments of the present disclosure relate to a method and apparatus for providing information based on an item search result list and, more particularly, to a method and an apparatus capable of determining information displayed on a page in consideration of the composition ratio of items included in the item search result list and whether a user has subscribed to a membership.

### Description of the Related Art

As the use of the Internet becomes more common, the e-commerce market is expanding. In particular, with the spread of infectious diseases, the proportion of purchasing products by visiting offline stores is decreasing, while the proportion of purchasing products through e-commerce transactions using computers or smartphones is rapidly increasing.

Meanwhile, some e-commerce companies operate a paid membership system that provides additional special benefits compared to free membership. Additional discounts, special delivery benefits such as early morning delivery, same day delivery, etc. are provided for members who have signed up for paid membership, and this information is displayed on the product sale page to induce subscription to the membership. For example, Korean Patent Registration No. 2198932 discloses a configuration for guiding whether a product is eligible for membership benefits based on an electronic receipt, and providing a membership benefit corresponding to the target product.

However, there is inevitably a limit on the number of items that can apply additional discounts or special delivery as a membership benefit. If membership benefits are displayed in the search result list of items without considering this, when searching for items that are difficult to apply membership benefits, customers may feel that the membership benefits received are relatively small, which may lead to dissatisfaction with membership subscription. Therefore, in displaying the membership benefits in the search result list of items, it is necessary to prevent the risk of feeling that membership benefits are somewhat small by displaying the item's search result list in consideration of the composition.

### SUMMARY

### Technical Goals

An aspect is to selectively display information such as membership subscription benefits in consideration of the composition ratio of items included in the item search result list. Another aspect is to efficiently determine and display information to be displayed on the page depending on a user who sees the displayed information in consideration of whether the user has subscribed to a membership.

### Technical Solutions

According to an aspect, there is provided a method of providing information on a server, the method including obtaining a keyword from a user, identifying an item list corresponding to the keyword, identifying a ratio of items corresponding to a specific type among a plurality of items included in the item list, and, when the item corresponding to the specific type is an item that provides benefits related to membership subscription, and the ratio of the items satisfies a specific condition, providing a first page including first information related to the item list and second information on or regarding the benefits related to the membership subscription for the item corresponding to the specific type in the item list.

The method further includes, when the item corresponding to the specific type is an item that provides the benefits related to the membership subscription, and the ratio of the items does not satisfy the specific condition, providing a first page including the first information but omitting the second information.

The method further includes providing a second page including detailed information on an item selected according to an input corresponding to the first information and information on the benefits related to the membership subscription for the selected item.

The second information is set differently depending on whether the user has subscribed to a membership, and the method further includes, when the item corresponding to the specific type is an item that provides the benefits related to the membership subscription, and the user does not subscribe to the membership, providing a third page for membership subscription in response to an input corresponding to the information on the benefits.

The method further includes providing a fourth page including information on the item list selected by the user and information on the benefits related to the membership subscription for at least some of the items included in the selected item list, and the information on the benefits is determined based on item information included in the selected item list.

The benefits related to the membership subscription include at least one of a price discount, application of special delivery, or provision of money accumulation at the time of purchase.

The second information includes a plurality of benefit information related to the membership subscription, and an order in which the plurality of benefit information is displayed on the first page is determined based on the purchase history of the user.

The method further includes, when the item corresponding to the specific type is an item whose number of reviews is less than or equal to a reference number, and the ratio of the items satisfies a specific condition, providing a first page including first information related to the item list and second information on benefits that can be received when writing a review of the item.

The method further includes, when the item corresponding to the specific type is an item whose rating is lower than or equal to a reference rating, and the ratio of the items satisfies a specific condition, providing a first page including first information related to the item list and third information including rating information for the item, and, when the item corresponding to the specific type is an item whose rating is lower than or equal to a reference rating, and the ratio of the items does not satisfy the specific condition, providing a first page including first information related to the item list but omitting the third information.

When the item corresponding to the specific type is the item whose rating is lower than or equal to a reference rating, and the ratio of the items does not satisfy the specific condition, the first page further includes additional price discount information for the item whose rating is lower than or equal to the reference rating.

The benefits related to the membership subscription vary depending on at least one of a type of the item, an address of the user, or a time.

According to another aspect, there is also provided a method of providing information on a user terminal, the method including obtaining a keyword, transmitting the obtained keyword to a server, receiving a first page from the server, the server being configured to identify an item list corresponding to the keyword, identify a ratio of items corresponding to a specific type among a plurality of items included in the item list, and, when the item corresponding to the specific type is an item that provides benefits related to membership subscription, and the ratio of the items satisfies a specific condition, provide a first page including first information related to the item list and second information on the benefits related to the membership subscription for the item corresponding to the specific type in the item list, and displaying the received first page.

According to another aspect, there is also provided a server providing information including a transceiver configured to transmit and receive information to and from other devices, and a processor controlling the transceiver and configured to obtain a keyword from a user, identify an item list corresponding to the keyword, identify a ratio of items corresponding to a specific type among a plurality of items included in the item list, and, when the item corresponding to the specific type is an item that provides benefits related to membership subscription, and the ratio of the items satisfies a specific condition, providing a first page including first information related to the item list and second information on the benefits related to the membership subscription for the item corresponding to the specific type in the item list.

According to another aspect, there is also provided a user terminal providing information including a transceiver configured to transmit and receive information to and from other devices, and a processor controlling the transceiver and configured to obtain a keyword, transmit the obtained keyword to a server, receive a first page from the server, the server being configured to identify an item list corresponding to the keyword, identify a ratio of items corresponding to a specific type among a plurality of items included in the item list, and, when the item corresponding to the specific type is an item that provides benefits related to membership subscription, and the ratio of the items satisfies a specific condition, provide a first page including first information related to the item list and second information on the benefits related to the membership subscription for the item corresponding to the specific type in the item list, and display the received first page.

### Effects

According to example embodiments, it is possible to obtain the effect of inducing membership subscription by making it easy for consumers to recognize that there are many items to which membership benefit is applied by displaying the benefit information only when the item to which the membership benefit can be applied is more than a certain percentage in the search result list of items.

According to example embodiments, it is possible to prevent a user's purchase motivation from lowering due to the low rating of the item exposed in the list by displaying the rating information only when the ratio of the items with the purchaser's rating above the reference rating in the item search result list is above a certain ratio.

According to example embodiments, it is possible to encourage a user who purchased the item to write a review by displaying information informing that there is a benefit from writing a review when the ratio of the items with purchaser's reviews of less than the reference number in the item search result list is above a certain ratio.

According to example embodiments, an advertisement effect that induces membership subscription can be obtained by differently displaying membership benefit information depending on whether or not a user has signed up for a membership by notifying the member who has joined the membership of the benefit information that can be received as a current member and notifying the user who does not have a membership of the benefits that can be enjoyed when registering for a membership.

### BRIEF DESCRIPTION OF THE DRAWINGS

FIG. 1 is a diagram schematically illustrating a configuration of an information providing system based on an item search result list according to an example embodiment of the present disclosure.

FIG. 2 is a sequence diagram illustrating information exchange between nodes related to a method of providing information based on an item search result list according to an example embodiment of the present disclosure and an operation corresponding thereto.

FIGS. 3A to 3C are diagrams for explaining a page displaying membership benefit information based on a search result list of items according to an example embodiment of the present disclosure.

FIGS. 4A to 4D are diagrams for describing a page displaying review information of an item based on a search result list of an item according to an example embodiment of the present disclosure.

FIGS. 5A to 5B are diagrams for explaining a page displaying membership benefit information based on whether a user has subscribed to a membership, according to an example embodiment of the present disclosure.

FIG. 6 is a flowchart illustrating a flow of a method for providing information in a server according to an example embodiment of the present disclosure.

FIG. 7 is a flowchart illustrating a flow of a method for providing information in a user terminal according to an example embodiment of the present disclosure.

FIG. 8 is a diagram illustrating some components of an information providing system according to an example embodiment of the present disclosure.

### DETAILED DESCRIPTION

Example embodiments of the present disclosure are described in detail with reference to the accompanying drawings.

Detailed descriptions of technical specifications well-known in the art and unrelated directly to the present disclosure may be omitted to avoid obscuring the subject matter of the present disclosure. This aims to omit unnecessary description so as to make clear the subject matter of the present disclosure.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the exemplary embodiments set forth herein. Rather, these exemplary embodiments are provided so that this disclosure will be thorough and complete and will fully convey the concept of the disclosure to those skilled in the art, and the present disclosure will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

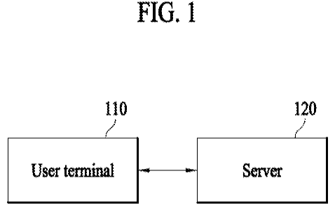

FIG. 1 is a diagram schematically illustrating a configuration of an information providing system based on an item search result list according to an example embodiment of the present disclosure.

Referring to FIG. 1, the information providing system according to an example embodiment of the present disclosure includes a user terminal 110 and a server 120. In an example embodiment, the server 120 may process information related to the operation of a service and provide it to a user.

Using the user terminal 110, an e-commerce user may access the server 120. The user terminal 110 has an e-commerce application installed, may access the server 120 using the application, and may use an e-commerce transaction based on information exchange with the server 120. The user terminal 110 may be a mobile device such as a smartphone and a tablet PC, or a static device such as a desktop PC, and any device in which an e-commerce application is installed and executed may be used as the user terminal 110 without limitation.

The server 120 communicates with the user terminal 110 and provides information related to e-commerce to the user terminal 110. A list of items may be provided as a result of searching the database, or detailed information of each item stored in the database may be provided. In the case of items directly delivered by e-commerce companies, an entity related to the service operated by the server may buy the product and manage the delivery. In the case of items delivered by other delivery companies, purchase information and delivery address information about items purchased by the user may be transmitted to the server of other delivery companies.

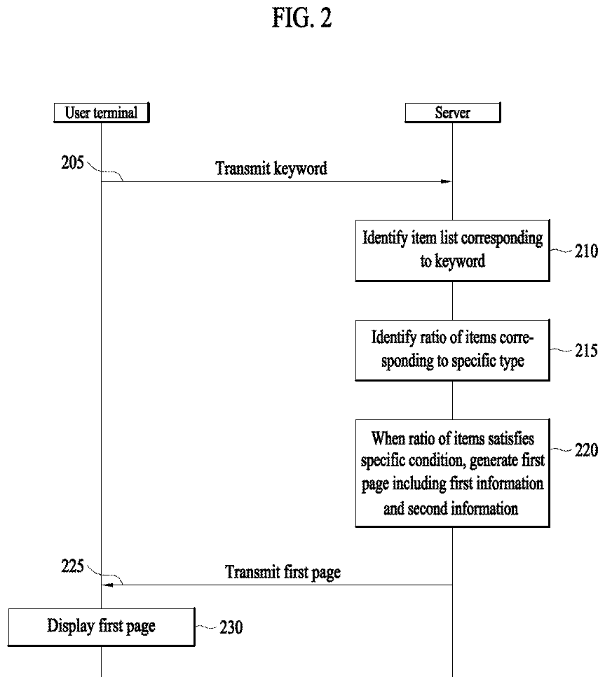

FIG. 2 is a sequence diagram illustrating information exchange between nodes related to a method of providing information based on an item search result list according to an example embodiment of the present disclosure and an operation corresponding thereto.

Referring to FIG. 2, a method of exchanging information between a user terminal and a server and operation at each node according to an example embodiment of the present disclosure are disclosed.

In operation 205, the user terminal may transmit a keyword of an item obtained from a user to the server to request a search. The keyword may be a generic name of an item or a specific name that limits a manufacturer, capacity, size, weight, and material of the item. The keyword may be inputted by the user directly into the search box through the user terminal, or the keyword listed on the page may be clicked or tapped by the user through the user terminal, or inputted by using another input device.

In operation 210, the server may identify an item list corresponding to the received keyword of the item. The item list may be a result of a database search for the received keyword of the item.

In operation 215, the server may identify a ratio of items corresponding to a specific type among a plurality of items included in the item list. The server may set the information displayed on a page differently by identifying the ratio of the items corresponding to the specific type in the item list. In an example embodiment, the item corresponding to the specific type may be an item that provides benefits related to a membership subscription. In an example embodiment, the item corresponding to the specific type may be an item in which the number of written reviews is less than or equal to a reference number. In an example embodiment, the item corresponding to the specific type may be an item in which the item's rating is lower than or equal to a reference rating.

In operation 220, when the ratio of the items satisfies a specific condition, the server may generate a first page including first information and second information. The first information may relate to an item list including a search result of the keyword, and the second information relates to the item corresponding to the specific type, and it may include, for example, information on or regarding benefits related to a membership subscription, additional price discount information, and benefits that can be received when writing a review. In an example embodiment, the benefits related to the membership subscription may be applied differently for each product, and the server may determine information included when providing a product search page or a detailed page in consideration of specific information of such benefits.

The first page generated by the server may be a page that obtains information on a corresponding item from a database that manages item information based on a keyword, and displays a search result including the item corresponding to the keyword. The first page may include information corresponding to the search keyword, and may include information on the item such as, for example, a picture, a price, a manufacturer, and the like of the item corresponding to the search keyword. In addition, the page may provide delivery information of the item such as estimated delivery time, guaranteed delivery time, and special delivery (for example, a delivery service that guarantees faster delivery than regular delivery, a periodic delivery of the product upon request, early morning delivery that guarantees the delivery of the product in the early morning of the next day after ordering), benefit information such as membership discount, applicable coupons, and money accumulation, and review information such as reviews and ratings of other purchasers as well as the above information related to the item. In listing the items that satisfy the search request, the number of items displayed per page may be selected by the user (for example, 36, 48, 60, 72, etc.).

In addition, the first page generated by the server may be a page displaying detailed information of a specific item. A user may enter a page displaying detailed information about an item through an input corresponding to information related to a specific item from the page displaying the search result of the item through the user terminal, and the server may provide such a page. The page may contain detailed information including the item's picture, size, weight, color, material, etc., reviews of the item, item inquiry, shipping/exchange/return information, etc. Also, interactive elements such as “Buy Now”, “Add to Cart”, and a field for selecting a quantity may be contained.

Also, the first page generated by the server may be a shopping cart page listing items selected by the user. A user may enter the shopping cart page by clicking on an icon on an item's search results page, an item's detailed information page, or another page, or by interacting in another way. The selected item may be added to the virtual shopping cart by clicking one or more items on the item's search result page or clicking an icon on the item's detailed information page. In one example embodiment, the page not only lists all the items that the user has added to the virtual shopping cart, but also displays information on the items in the shopping cart such as the quantity of each item, unit price of each item, price based on the relevant quantity of each item, expected delivery date, delivery method, shipping fee, interactive elements for modifying items in the shopping cart (e.g., item deletion or quantity modification), options for ordering other items or setting up periodic delivery of items, interactive elements for making purchases, and so on.

In one example embodiment, when an item corresponding to a specific type is an item that provides benefits related to a membership subscription, and a ratio of the items satisfies a specific condition, the server may generate the first page including the first information related to the item list and the second information on the benefits related to the membership subscription for the item corresponding to the specific type in the item list. The second information that may be displayed along with the item list is a benefit that is applied only when signing up for a membership, and may include information on price discounts, special delivery, and money accumulation. The benefits applied when signing up for membership may vary depending on the type of item, user's address, and time. In this way, in determining the second information to be displayed, the server may consider whether the ratio of items corresponding to the specific type of the item list on the page displaying the search result of the item satisfies the specific condition. Information to be displayed may vary according to whether or not such specific condition is satisfied.

For example, if the number of items displayed in the list per page is 20, and if 50% or more of the items (i.e., more than 10 items) are eligible for the benefit from membership subscription, the original selling price of the item and the membership discount price may be displayed together for items that can benefit from the membership subscription. In addition, if the number of items that can be delivered on the same day as a membership subscription benefit is 30% or more (that is, 6 or more), a phrase stating “This item is an item covered by membership benefits and can be delivered on the same day” may be displayed for the items that can be delivered on the same day. At this time, availability of same day delivery may vary depending on the delivery address entered by the user when signing up for the membership and the current time. On the other hand, if the number of items that can benefit from the membership subscription is less than 50% (i.e., less than 10 items), the page may only displays the first information indicating the search result, and the second information on the benefits related to the membership subscription may not be displayed. In this way, by displaying the benefit information only when the items to which the membership benefit can be applied are more than a certain percentage in the list, it is possible to obtain the effect of inducing membership subscription by making it easy for consumers to recognize that there are many items to which membership benefit is applied. In an example embodiment, a specific ratio for determining whether to display information may be set differently depending on types of product.

Meanwhile, for a plurality of membership subscription benefit information displayed according to whether the list of items to be listed satisfy a specific condition in stages, the display order of the plurality of membership subscription benefit information may be determined according to the purchase history of the user. For example, referring to the user's purchase history, if it is determined that the user prefers an item to which a special delivery benefit is applied over an item to which a price discount is applied, when the list of items listed in the search result satisfies a specific condition, the page may be configured to display special delivery benefit information first, and then display price discount benefit information when the next certain condition is satisfied.

As another example embodiment, when an item corresponding to a specific type is an item whose rating is less than or equal to a reference rating, and the ratio of the items satisfies a specific condition, the first page including first information related to the item list and a third information including rating information for the item may be generated. Meanwhile, when the ratio of the items does not satisfy the specific condition, the first page may be generated to include the first information related to the item list but omit the third information including rating information for the item. For example, when the number of items displayed in the list per page is 20, and among them, items with the purchaser's rating of 4 points (out of 5 points) or more are 20% or less (that is, 4 or less), the purchaser's rating information may be omitted from the page that displays the search results for items. Alternatively, in the page displaying the search result of the item, instead of including the purchaser's rating information, an additional discount may be applied to the existing discount price and displayed together with the original selling price of the item. Through such an example embodiment, it is possible to prevent a user's purchase motivation from lowering due to the low rating of the item exposed on the list, and increase the user's purchase motivation and purchase satisfaction of the item through an additional discount.

As another example embodiment, when an item corresponding to a specific type is an item having reviews of less than or equal to a reference number, and a ratio of items satisfies a specific condition, the first page including the first information related to the item list and the second information on benefits that can be received when writing a review may be generated. For example, when the number of items displayed in the list per page is 20, and 80% or more (that is, 16 or more) items among them have 100 or less reviews written by purchasers, a phrase informing that there are benefits such as “Get additional money accumulation when writing a review after purchasing this item” or “Get a coupon when writing a review after purchasing this item” may be displayed along with the items. Through such an example embodiment, an effect of encouraging the user who has purchased the item to write a user review may be expected.

In an example embodiment, the second information related to the membership subscription benefit may be set differently depending on whether the user subscribes to the membership. For example, if the user has a membership, the second information may include information about benefits such as price discounts, special delivery, and money accumulation that the user can receive as a member. If the user does not have a membership, the second information may include a phrase indicating that the user may receive benefits such as price discounts, special delivery, and money accumulation upon subscribing to the membership. Additionally, the server may be implemented such that the user may access a membership subscription page by clicking or tapping a phrase indicating benefits provided upon registering for a membership when the user is not a member. Through such an example embodiment, an advertisement effect that induces membership subscription may be obtained by notifying the member who has joined the membership of the benefit information that can be received as a current member, and notifying the user who does not have a membership of the benefits that can be enjoyed when registering for a membership.

Meanwhile, information related to membership subscription benefits may be displayed not only on the page listing the search results of the item, but also on the item detail page showing detailed information of the item or the shopping cart page showing the items in the virtual shopping cart, as described further below.

In one example embodiment, the server may generate a shopping cart page that includes information on or regarding a list of items selected by the user to be included in the virtual shopping cart and information on benefits related to membership subscription for at least some of the items included in the selected item list. The information on the benefits may be determined based on the item included in the selected item list. For example, if all items included in the selected item list included in the virtual shopping cart are items to which benefits related to membership subscription are applied, the page may display information for discounting the membership subscription fee. As another example, if all of the items constituting the selected item list included in the virtual shopping cart are items eligible for early morning delivery, the page may display a separate message indicating that the early morning delivery benefit is available.

In operation 225, the server may transmit the generated first page to the user terminal.

In operation 230, the user terminal may display the received page through the display part.

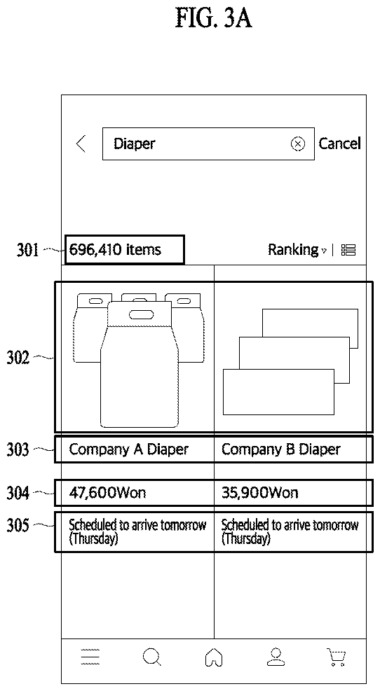

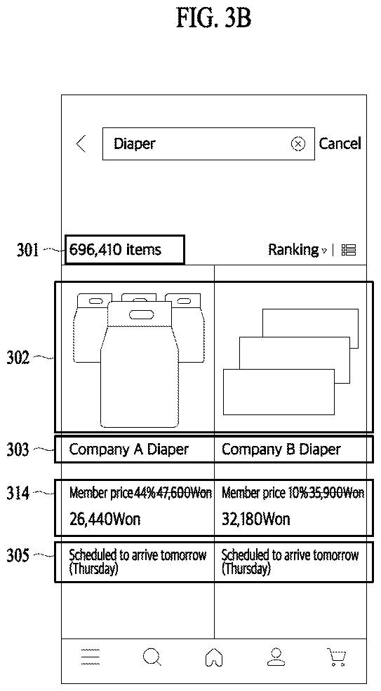

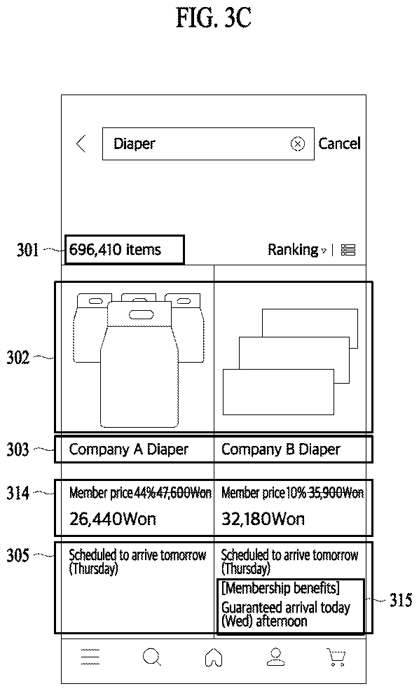

FIGS. 3A to 3C are diagrams for explaining a page displaying membership benefit information based on a search result list of items according to an example embodiment of the present disclosure.

FIG. 3A is a diagram illustrating an exemplary search result page of items that a user may view by entering a keyword “diaper” in a search box through a user terminal. The item search result page may display the number of searched items 301, a picture of an item 302, a name of the item 303, a selling price of the item 304, delivery information 305 of the item, or the like.

FIG. 3B is a diagram illustrating that a list of items listed on an exemplary search result page of items satisfies a specific condition to display a discounted price 314 together with a selling price 304 of the item. Specific conditions are, for example, when the number of items listed per page is 20, that 50% or more (i.e., 10 or more) items are eligible for membership subscription benefits, or that 40% or more (i.e., 8 or more) items are eligible for a discount of 10% or more as membership subscription benefits. On the other hand, if the list of items does not satisfy the specific condition, that is, for example, if the number of items that can benefit from membership subscription is less than 50% (i.e., less than 10), the page shows only the selling price 304 of the item as in FIG. 3A, and information on the discounted price 314 that can be enjoyed as a membership subscription benefit may not be displayed. This may be applied regardless of whether the two items shown in FIG. 3A are items that can enjoy membership subscription benefits.

FIG. 3C is a diagram illustrating displaying information 315 notifying that an item is eligible for same day delivery because a list of items listed on an exemplary item search result page satisfies other specific conditions. Other specific conditions may include, for example, that when the number of items listed per page is 20, 30% or more (i.e., 6 or more) items among them are eligible for the same day delivery as a membership subscription benefit. If the condition is satisfied, information 315 indicating that same day delivery is possible may be displayed for items that can be delivered on the same day, and original delivery information 305 may be displayed for items that cannot be delivered on the same day. On the other hand, if the condition is not satisfied, that is, if the number of items that can be delivered on the same day as a membership subscription benefit is less than 30% (i.e., less than 6), information indicating that same day delivery is possible may not be displayed on the page.

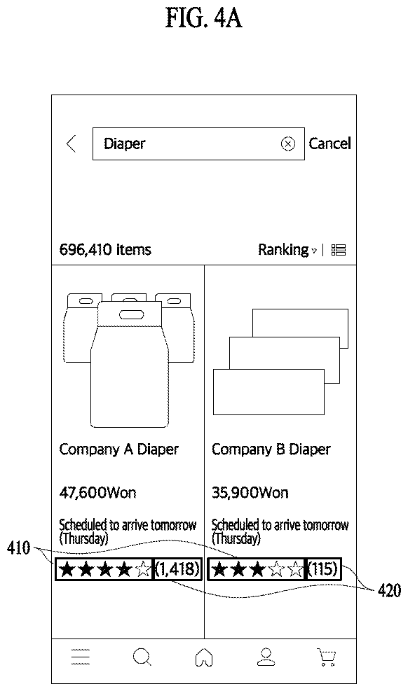

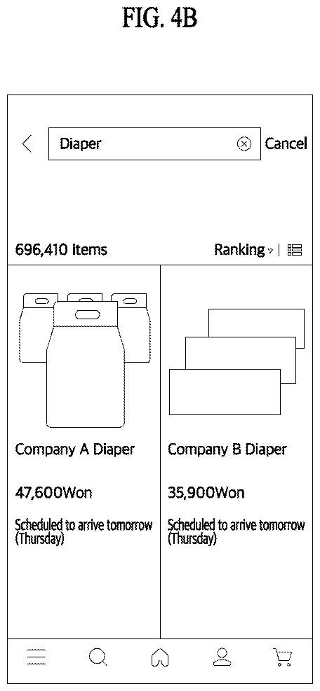

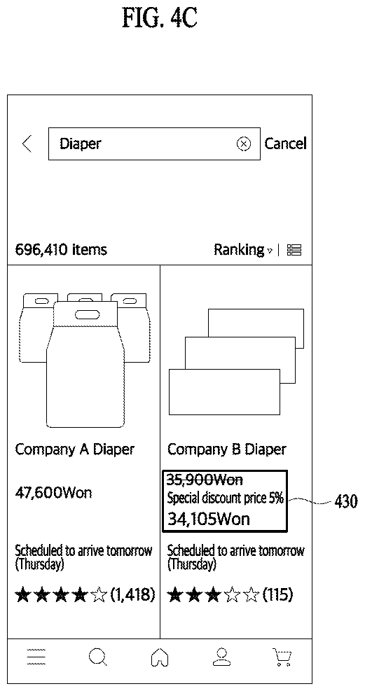

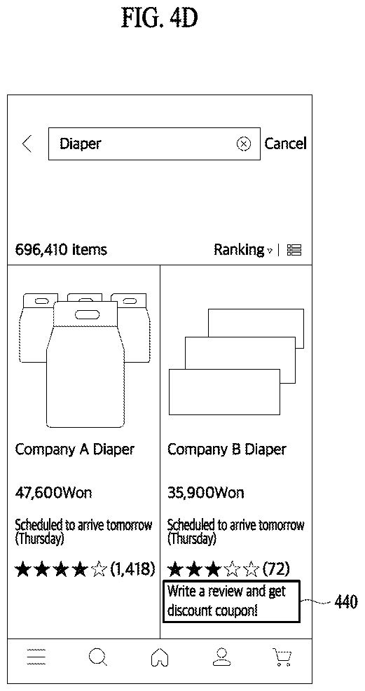

FIGS. 4A to 4D are diagrams for describing a page displaying review information of an item based on a search result list of an item according to an example embodiment of the present disclosure.

In the exemplary item search result page of FIG. 4A, the purchase rating 410 of the user who purchased the item and the number of purchase reviews written by the user 420 may be displayed. By clicking or tapping this, a user may enter a page (not shown) showing a list of ratings and reviews.

FIG. 4B is a diagram illustrating an example embodiment in which a list of items to be listed satisfies a specific condition on an exemplary item search result page, so that purchase ratings and reviews of items are not displayed. A specific condition may include, for example, that when the number of items listed per page is 30, items with a purchaser's rating of 4 points (out of 5 points) or more among them are 20% or less (i.e., 6 or less). When the corresponding condition is satisfied, by excluding purchase rating and review information of the item from information displayed on the search result page 400, it is possible to prevent a user's purchase motivation from lowering due to the low rating of the item listed in the list.

FIG. 4C is an exemplary item search result page, rather than displaying information excluding the purchase rating and the number of reviews, as shown in FIG. 4B, displaying an additionally discounted price 430 together with the purchase rating 410 and the number of reviews 420 for the item with a low purchase rating. Even if the item has a low purchase rating, it is possible to increase the customer's purchase motivation and purchase satisfaction for the item at a discounted price.

FIG. 4D is an exemplary item search result page, in which a list of items to be listed satisfies other specific conditions, and thus, benefit information 440 that can be received when writing a review for the item is displayed together with a purchase rating 410 and the number of reviews 420. Other specific conditions include, for example, that when the number of items displayed in the list per page is 20, 80% or more (i.e., 16 or more) items among them have 100 or less reviews written by purchasers. By encouraging to write reviews on items with few purchase reviews through the above example embodiment, it is possible to increase the purchase motivation of potential purchasers to select after viewing the reviews.

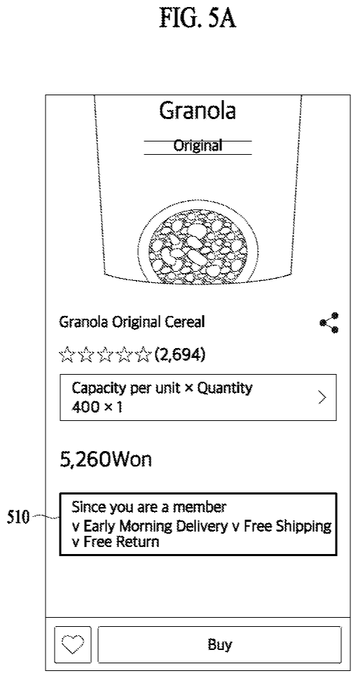

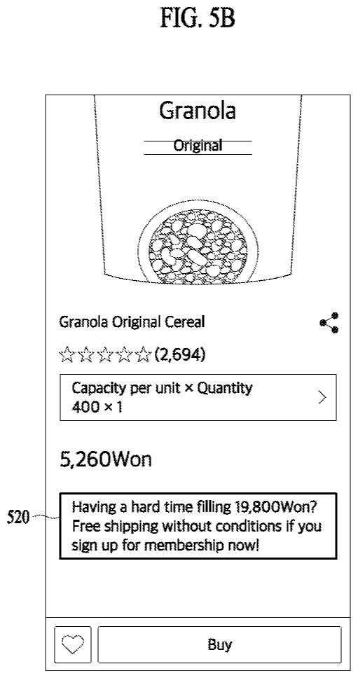

FIGS. 5A to 5B are diagrams for explaining a page displaying membership benefit information based on whether a user has subscribed to a membership, according to an example embodiment of the present disclosure.

FIG. 5A is an exemplary detailed information page of an item displayed when a user has subscribed to a membership, and it displays information 510 indicating benefits that the user can receive as a member of the membership subscription. In FIG. 5A, the page informs that the user can receive benefits such as early morning delivery, free delivery, and free return for this item because the user has a membership. User satisfaction with the membership subscription may increase by displaying such information.

FIG. 5B is an exemplary detailed information page of an item displayed when a user has not subscribed to a membership. By displaying information 520 indicating benefits that can be received if the user subscribes to a membership, it is possible to induce the user to join the membership. In FIG. 5B, the page informs that the user is not currently a member, but if the user signs up as a member, the user can obtain a benefit of free shipping without conditions. In one example embodiment, the user may enter the membership subscription page by clicking or tapping the benefit information 520.

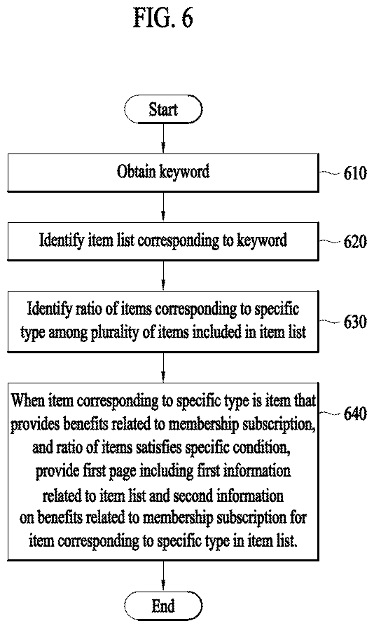

FIG. 6 is a flowchart illustrating a flow of a method for providing information in a server according to an example embodiment of the present disclosure.

In operation 610, the server may receive a keyword of an item from a user terminal. The keyword may be a generic name of an item or a specific name that limits a manufacturer, capacity, size, weight, and material of the item. The keyword may be inputted by the user directly into the search box through the user terminal, or the keyword listed on the page may be clicked or tapped by the user through the user terminal, or inputted by using another input device.

In operation 620, the server may identify an item list corresponding to the received keyword of the item. The item list may be a result of a database search for the received keyword of the item.

In operation 630, a ratio of items corresponding to a specific type among a plurality of items included in the item list may be identified. The server may set the information displayed on the page differently by identifying the ratio of the items corresponding to the specific type in the item list. In an example embodiment, the item corresponding to the specific type may be an item that provides benefits related to membership subscription. In an example embodiment, the item corresponding to the specific type may be an item in which the number of written reviews is less than or equal to a reference number. In an example embodiment, the item corresponding to the specific type may be an item in which the item's rating is lower than or equal to a reference rating.

In operation 640, when the item corresponding to the specific type is an item that provides benefits related to membership subscription and the ratio of the items satisfies a specific condition, a first page including first information related to the item list and second information on benefits related to membership subscription for the item corresponding to a specific type of item list. The second information that may be displayed along with the item list is benefits applied only when signing up for a membership, which may include information on price discounts, special delivery, money accumulation, and so on. The benefits applied upon signing up for a membership may vary depending on the type of item, the user's address, the time, etc. In this way, in determining the second information to display, the server may consider whether the ratio of the items corresponding to a specific type of the item list on the page displaying the search result of the item satisfies a specific condition.

For example, if the number of items displayed in the list per page is 20, and if 50% or more of the items (i.e., more than 10 items) are eligible for the benefits from membership subscription, the original selling price of the item and the membership discount price can be displayed together for the items that can benefit from membership subscription. In addition, if the number of items that can be delivered on the same day as a membership subscription benefit is 30% or more (that is, 6 or more), a phrase stating “This item is an item covered by membership benefits and can be delivered on the same day” may be displayed for the items that can be delivered on the same day. At this time, availability of same day delivery may vary depending on the delivery address entered by the user when signing up for membership and the current time. On the other hand, if the number of items that can benefit from membership subscription is less than 50% (i.e., less than 10 items), the page may only display the first information indicating the search result, and the second information on the benefits related to membership subscription may not be displayed. In this way, by displaying the benefit information only when the items to which the membership benefit can be applied are more than a certain percentage in the list, it is possible to obtain the effect of inducing membership subscription by making it easy for consumers to recognize that there are many items to which the membership benefit is applied. In an example embodiment, the specific ratio for determining whether to display information may be set differently depending on types of product.

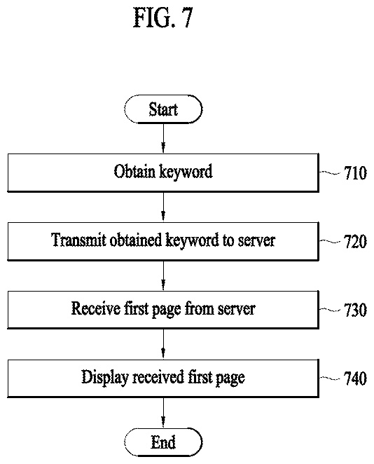

FIG. 7 is a flowchart illustrating a flow of a method for providing information in a user terminal according to an example embodiment of the present disclosure.

In operation 710, the user terminal may receive a keyword of an item from a user. The keyword may be a generic name of an item or a specific name that limits a manufacturer, capacity, size, weight, and material of the item. The keyword may be inputted by the user directly into the search box through the user terminal, or the keyword listed on the page may be clicked or tapped by the user through the user terminal, or inputted by using another input device.

In operation 720, the user terminal may transmit the obtained keyword of the item to a server.

In operation 730, the user terminal may receive a first page from the server. At this time, the first page may include first information and second information. The first information may relate to an item list including a search result of the keyword, and the second information relates to the item corresponding to the specific type, and it may include, for example, information on or regarding benefits related to membership subscription, additional price discount information, and benefits that can be received when writing a review.

In operation 740, the user terminal may display the received first page through a display part.

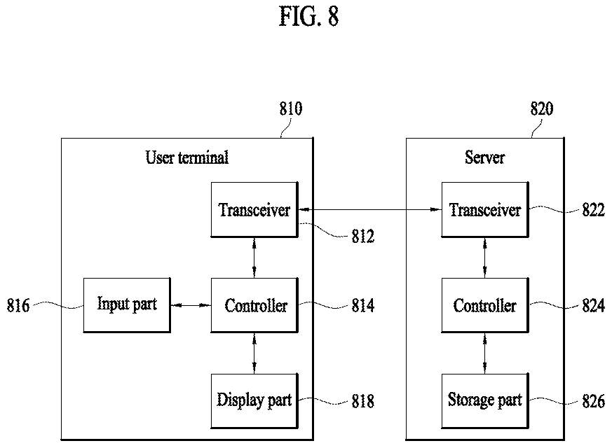

FIG. 8 is a diagram illustrating some components of an information providing system according to an example embodiment of the present disclosure.

Referring to FIG. 8, an information providing system according to an example embodiment of the present disclosure is shown, and the system includes a user terminal 810 and a server 820 capable of communicating with each other.

The user terminal 810 may execute an e-commerce client program and may include a transceiver 812, a controller 814, an input part 816, and a display part 818.

The transceiver 812 may transmit and receive information with other nodes including the server 820.

The input part 816 may receive a user's input, and may include a touch screen, a microphone, and a button.

The display part 818 may display information related to the operation of the user terminal 810 and may display a page including the information described in the example embodiment.

The controller 814 may perform control to perform the operation of the user terminal 810 described in the example embodiment. In addition, the controller 814 may include at least one processor.

In addition, the user terminal 810 may further include a speaker for outputting an event, and a storage part (not shown) for storing at least some of information transmitted and received through the transceiver 812 and information for operation of the user terminal 810 may be further included.

The server 820 is a device on which an e-commerce server program is being executed, and may include a transceiver 822, a controller 824, and a storage part 826.

The transceiver 822 may transmit and receive information with other nodes including the user terminal 810.

The controller 824 may perform control to perform the operation of the server 820 described in the example embodiment. In addition, the controller 824 may include at least one processor.

In addition, the server 820 may include a storage part 826 for storing at least some of information transmitted and received through the transceiver 822 and information for operation of the server 820.

Example embodiments of the present disclosure have been disclosed in the present specification and drawings. Although specific terms are used, these are only used in general meaning to easily explain the technical content of the present disclosure and to aid understanding of the present disclosure, but not intended to limit the scope of the present disclosure. It is obvious to those skilled in the art that other modified examples based on the technical idea of the present disclosure can be implemented in addition to the example embodiments disclosed herein.

Description of reference numerals

110: User terminal

120: Server

1. A method operable by an electronic apparatus to provide information based on user input for an item search, the method comprising:
controlling, by a processor of the electronic apparatus, a transceiver of the electronic apparatus to communicate with a user terminal of a user;
obtaining, by the processor of the electronic apparatus, a keyword from the user terminal;
identifying, by the processor of the electronic apparatus, a list of a plurality of items corresponding to the keyword;
generating, by the processor of the electronic apparatus, code configured to cause the user terminal to display a first page comprising an image of at least one item of the plurality of items, first information related to pricing of the at least one item, and rating information associated with the at least one item;
identifying, by the processor of the electronic apparatus, a first subset of items corresponding to a specific type among the plurality of items, wherein the first subset of items corresponding to the specific type are eligible for benefits related to a membership subscription;
determining, by the processor of the electronic apparatus, a first ratio between the first subset of items corresponding to the specific type and the plurality of items included in the list;
in response to determining that the first ratio meets or exceeds a first predefined value, causing, by the processor of the electronic apparatus, an automatic updating of the first page to display second information for the first subset of items while maintaining at least one of the image of the at least one item or the first information on the first page, wherein the second information is indicative of the benefits relating to the first subset of items;
in response to determining that the first ratio does not meet or exceed the first predefined value, causing, by the processor of the electronic apparatus, an automatic updating of the first page not to include the second information;
identifying, by the processor of the electronic apparatus, a second subset of items among the plurality of items, wherein the second subset of items includes items whose ratings are higher than or equal to a reference rating;
determining, by the processor of the electronic apparatus, a second ratio between the second subset of items and the plurality of items included in the list and
in response to determining that the second ratio is less than or equal to a second predefined value, causing, by the processor of the electronic apparatus, an automatic updating of the first page based on one of: removing the rating information, or displaying additional discount information along with the rating information.

2. (canceled)

3. The method of claim 1, further comprising:
receiving a selection of an item;
providing a second page including detailed information based on the corresponding first information and the second information for the selected item.

4. The method of claim 1, wherein the second information is set differently depending on whether the user has subscribed to a membership, and the method further comprises:
in response to determining that the user is not subscribed to the membership, providing a third page for membership subscription in response to an input corresponding to the second information.

5. The method of claim 1, further comprising:
receiving a list of items selected by the user;
providing a fourth page including information regarding the selected list of items and information regarding benefits related to membership subscription for at least some of items included in the selected list of items,
wherein the information regarding benefits is determined based on item information included in the selected list of items.

6. The method of claim 1, wherein the benefits related to the membership subscription include at least one of a price discount, application of special delivery, or provision of money accumulation at the time of purchase.

7. The method of claim 1, wherein:
the second information includes a plurality of benefit information related to the membership subscription; and
an order in which the plurality of benefit information is displayed on the first page is determined based on the purchase history of the user.

8. The method of claim 1, further comprising:
identifying, by the processor of the electronic apparatus, a third subset of items among the plurality of items, wherein the third subset of items include items whose number of reviews is less than or equal to a reference number;
determine, by the processor of the electronic apparatus, a ratio between the third subset of items and the plurality of items included in the list; and
in response to determining that the ratio between the third subset of items and the plurality of items included in the list meets or exceeds a third predefined value, causing, by the processor of the electronic apparatus, an automatic update of the first page to display third information regarding benefits to be received for writing a review of an item of the third subset of items.

9. (canceled)

10. (canceled)

11. The method of claim 1, wherein the benefits related to the membership subscription vary depending on at least one of a type of an item, an address of the user, or time.

12. A method of providing information on a user terminal, the method comprising:
communicating with an electronic apparatus configured to provide information based on user input for an item search;
obtaining a keyword;
transmitting the keyword to the electronic apparatus;
in response to code from the electronic apparatus, displaying a first page comprising an image of at least one item of a plurality of items, first information related to pricing of the at least one item, a list of the plurality of items corresponding to the keyword, and rating information associated with the at least one item; and
displaying an updated first page received from the electronic apparatus, the updated first page configured to display second information indicative of membership subscription benefits relating to a first subset of items of the plurality of items,
wherein the updated first page shows the second information while maintaining at least one of the image of the at least one item or the first information on the first page,
wherein the updated first page is displayed by the user terminal in response to determining, by the electronic apparatus, that a first ratio between the subset of items and the plurality of items meets or exceeds a predetermined value,
wherein the updated first page is displayed not including the second information in response to determining, by the electronic apparatus, that the first ratio does not meet or exceed the first predefined value,
wherein the updated first page is displayed based on one of: removing the rating information, or displaying additional discount information along with the rating information, in response to determining, by the electronic apparatus, that a second ratio is less than or equal to a second predefined value,
wherein the second ratio is a ratio between a second subset of items among the plurality of items, and the plurality of items in the list,
wherein the second subset of items includes items whose ratings are higher than or equal to a reference rating.

13. An electronic apparatus for providing information based on user input for an item search, the electronic apparatus comprising:
a transceiver configured to transmit and receive information to and from other devices; and
a processor controlling the transceiver and configured to:
obtain a keyword from a user terminal via the transceiver;
identify a list of a plurality of items corresponding to the keyword;
generate code configured to cause the user terminal to display a first page comprising an image of at least one item of the plurality of items, first information related to pricing of the at least one item, and rating information associated with the at least one item;
identify a subset of items corresponding to a specific type among the plurality of items, wherein the subset of items corresponding to the specific type are eligible for benefits related to a membership subscription;
determine a first ratio between the subset of items corresponding to the specific type and the plurality of items included in the list;
in response to determining that the first ratio meets or exceeds a predefined value, cause an automatic update of the first page to display second information for the subset of items while maintaining at least one of the image of the at least one item or the first information on the first page, wherein the second information is indicative of the benefits relating to the subset of items;
in response to determining that the first ratio does not meet or exceed the first predefined value, cause an automatic update of the first page not to include the second information;
identify a second subset of items among the plurality of items, wherein the second subset of items include items each having a rating that is higher than or equal to a reference rating;
determine a second ratio between the second subset of items and the plurality of items included in the list and
in response to determining that the second ratio is less than or equal to a second predefined value, cause an automatic update of the first page based on one of: removing the rating information, or display additional discount information along with the rating information.

14. A user terminal for providing information, the user terminal comprising:
a transceiver configured to transmit and receive information with other devices; and
a processor controlling the transceiver and configured to:
communicate with an electronic apparatus configured to provide information based on user input for an item search;
obtain a keyword;
transmit the keyword to the electronic apparatus;
in response to code received from the electronic apparatus, display a first page comprising an image of at least one item of the plurality of items, first information related to pricing of the at least one item, a list of the plurality of items corresponding to the keyword, and rating information associated with the at least one item;
display an updated first page received from the electronic apparatus, the updated first page configured to display second information indicative of membership subscription benefits relating to a first subset of items of the plurality of items,
wherein the updated first page shows the second information while maintaining at least one of the image of the at least one item or the first information on the first page,
wherein the updated first page is displayed by the user terminal in response to determining, by the electronic apparatus, a first ratio between the subset of items and the plurality of items meets or exceeds a predetermined value
wherein the updated first page is displayed not including the second information in response to determining, by the electronic apparatus, that the first ratio does not meet or exceed the first predefined value;
wherein the updated first page is displayed based on one of: removing the rating information, or displaying additional discount information along with the rating information, in response to determining, by the electronic apparatus, that a second ratio is less than or equal to a second predefined value,
wherein the second ratio is a ratio between a second subset of items among the plurality of items, and the plurality of items in the list, wherein the second subset of items includes items whose ratings are higher than or equal to a reference rating.
